(19) United States
(12) Patent Application Publication
(10) Pub. No.: US 2014/0261300 A1
(43) Pub. Date: Sep. 18, 2014

(54) FUEL INJECTION CONTROL APPARATUS FOR INTERNAL COMBUSTION ENGINE

(71) Applicant: DENSO CORPORATION, Kariya-city (JP)

(72) Inventor: Keisuke YANOTO, Kariya-city (JP)

(73) Assignee: DENSO CORPORATION, Kariya-city (JP)

(21) Appl. No.: 14/211,647

(22) Filed: Mar. 14, 2014

(30) Foreign Application Priority Data
Mar. 14, 2013 (JP) 2013-51531

(51) Int. Cl. F02D 41/30

(52) U.S. Cl. CPC F02D 41/3005
USPC 123/294

(57) ABSTRACT

A fuel injection control apparatus for an internal combustion engine includes a fuel injection valve and an ignition device. The fuel injection control apparatus further includes a determination unit and an injection control unit. The determination unit determines that an implementation condition is satisfied and the injection control unit controls the fuel injection valve. The injection control unit controls the fuel injection valve to (i) begin injecting fuel during a compression stroke of the engine and (ii) complete injecting fuel at an injection completion timing according to an ignition timing of the ignition device, during start period after the engine is started, when the implementation condition is satisfied.

### CROSS REFERENCE TO RELATED APPLICATION

This application is based on and incorporates herein by reference Japanese Patent Application No. 2013-51531 filed on Mar. 14, 2013.

### TECHNICAL FIELD

The present disclosure relates to a fuel injection control apparatus for an internal combustion engine.

### BACKGROUND

The usage of alcohol-containing fuels for internal combustion engines of vehicles has been considered. However, alcohol-containing fuels that include, for example, ethanol, are more difficult to vaporize than gasoline fuel. As a result, startability of an engine using alcohol-containing fuels may be deteriorated in low temperature environments. The engine may be much more difficult to start especially at low temperatures below freezing that are also below an ignition point of ethanol. To address such deterioration of engine startability, a technology in which so-called compression stroke injection is performed has been proposed (e.g., see a patent document 1 (JP 2010-37968 A)). Under the technology, when the engine is started at a state in which alcohol concentration of the fuel is higher than a given value and an engine temperature is lower than a given value, an injection completion timing of an injector is set in a compression stroke. In this case, the injection completion timing is set closer a compression top dead center (CTDC) as the alcohol concentration of the fuel increases or the engine temperature decreases.

While vaporization of gasoline fuel is generally promoted by securing time from the injection completion timing to an ignition timing, vaporization of the alcohol-containing fuel is generally promoted by setting the injection completion timing closer to the CTDC. Therefore, it is preferable for so-called flex fuel vehicles (FFV) to vary injection timing based on the alcohol concentration, which is different from a control of injection timing for the gasoline fuel.

According to the present application, in order to secure sufficient ignition performance even with high alcohol concentrations and in low temperature environments, it is important to ignite the air-fuel mixture in the vicinity of an electrode of an ignition plug before the air-fuel mixture is diffused. In this respect, current technologies may not provide sufficient ignition performance, and thus, even when the compression stroke injection is performed, startability of the engine may not be improved at particular ignition timings by merely setting the injection completion timing close to the CTDC.

### SUMMARY

It is an objective of the present disclosure to provide a fuel injection control apparatus that improves engine startability for an internal combustion engine using alcohol-containing fuels.

In an aspect of the present disclosure, a fuel injection control apparatus for an internal combustion engine includes a fuel injection valve for cylinder injection and an ignition device for spark ignition. The fuel injection control apparatus includes a determination unit determining that an implementation condition is satisfied when at least one of (i) an alcohol concentration in fuel supplied to the fuel injection valve is equal to or higher than a specific concentration value and (ii) a temperature of the engine is equal to or lower than a specific temperature value. The fuel injection control apparatus further includes an injection control unit configured to control the fuel injection valve. During a start period after the engine is started, when the implementation condition is satisfied, the injection control unit controls the fuel injection valve to (i) begin injecting fuel during a compression stroke of the engine and (ii) complete injecting fuel at an injection completion timing according to an ignition timing of the ignition device.

According to the aspect of the present disclosure, at least when the alcohol concentration in the fuel is higher than the specific concentration value or the engine temperature is lower than the specific temperature value, the fuel injection by the injector is performed in the compression stroke during the start period after the engine is started, and the injection completion timing is controlled based on the ignition timing of the ignition device. In this case, by controlling the injection completion timing based on the ignition timing, the fuel can be ignited before the fuel spray (i.e., combustible air-fuel mixture) is diffused from the vicinity of the ignition device in the combustion chamber. Accordingly, the sufficient ignition performance of the fuel spray can be secured. In other words, even under a high alcohol concentration state or a low temperature environment, in which the fuel is difficult to vaporize, the ignition performance can be improved by securing a firing source (i.e., a core for starting an ignition) in the fuel spray (i.e., a firing source before diffusion of the fuel spray). As a result, when the engine is started, startability for an engine using the alcohol-containing fuel can be improved.

### BRIEF DESCRIPTION OF THE DRAWINGS

The disclosure, together with additional objectives, features and advantages thereof, will be best understood from the following description, the appended claims and the accompanying drawings, in which:

FIG. 1 is a configuration diagram schematically illustrating a control system for a cylinder injection engine according to an embodiment of the present disclosure;

FIG. 2 is a timing chart schematically illustrating an injection completion timing control;

FIG. 3 is a timing chart schematically illustrating the injection completion timing control;

FIG. 4 is a flowchart showing a flow of an injection timing control;

FIG. 5 is a relation diagram used to set an ignition margin angle;

FIG. 6 is a relation diagram used to set a control period;

FIG. 7 is a timing chart used to describe variable setting of the ignition margin angle; and

FIG. 8 is a graph of an engine rotational speed at an engine start.

### DETAILED DESCRIPTION

An exemplary embodiment of the present disclosure with reference to

FIGS. 1 to 8 is described hereinafter. In the present embodiment, a multi-cylinder 4-cycle engine (i.e., an internal combustion engine) for a vehicle is a controlled object by an engine control system. The engine is a cylinder injection-type engine and various actuators provided to the engine are electrically controlled by the engine control system. The vehicle in the present embodiment is a so-called flex fuel vehicle (FFV) and the engine mounted in the vehicle is capable of using an alcohol-containing fuel made by mixing an alcohol, such as an ethanol, with a gasoline. First, a configuration of the engine control system will be schematically described based on FIG. 1.

In the cylinder injection type engine (hereinafter “engine 10”) shown in FIG. 1, an airflow meter 12 for detecting intake air amount is disposed on an upstream side of an intake pipe 11. A throttle valve 14 is disposed in the intake pipe 11 on a downstream side of the airflow meter 12 and an operation of the throttle valve 14 is controlled by a throttle actuator 13 such as a DC motor. Opening of the throttle valve 14 (i.e., throttle opening) is detected by a throttle opening sensor (not shown) incorporated in the throttle actuator 13. A surge tank 16 is disposed on a downstream side of the throttle valve 14 and an intake pipe pressure sensor 17 for detecting an intake pipe pressure is disposed to the surge tank 16. An intake manifold 18 is connected to the surge tank 16 and introduces air to the respective cylinders of the engine 10.

An injector 21 is connected to a cylinder block 20. The injector 21 is electromagnetically driven and directly injects the fuel into a combustion chamber 23 that is defined by an inner wall of the cylinder and a top surface (i.e., a top part) of a piston 22. The injector 21 is one examples of a “fuel injection valve” for cylinder injection. As described below, high pressure fuel is supplied to the injector 21 from a high pressure fuel system having a high pressure pump 26.

Next, the high pressure fuel system is briefly described. The system includes a low pressure pump 25, the high pressure pump 26, and a delivery pipe 27 (i.e., pressure accumulation pipe). The injector 21 of the respective cylinders is connected to the delivery pipe 27. The low pressure pump 25 pumps up the fuel in a fuel tank 24, and the high pressure pump 26 pressurizes the low pressure fuel pumped up by the low pressure pump 25. The delivery pipe 27 stores high pressure fuel discharged from the high pressure pump 26. The fuel tank 24 stores either one of the gasoline fuel or the alcohol-containing fuel made by mixing the gasoline and the alcohol, such as methanol. The high pressure fuel stored in the delivery pipe 27 is injected into the combustion chamber 23 (i.e., the cylinder) by the injector 21. A high pressure fuel pipe 28 connects between the high pressure pump 26 and the delivery pipe 27, and a fuel pressure sensor 29 for detecting pressure of the fuel (i.e., fuel pressure) is disposed as a fuel pressure detecting device for the high pressure fuel pipe 28.

The high pressure pump 26 is a mechanical pump driven by rotation of an engine camshaft (not shown). A fuel discharge amount of the high pressure pump 26 is controlled by a fuel pressure control valve (not shown) disposed to the high pressure pump 26. The fuel pressure in the delivery pipe 27 is pressurized to about 10 to 20 MPa, for example. The low pressure pump 25 is an electrical pump.

A concentration sensor 30 for detecting alcohol concentration in the fuel is connected to the high pressure fuel pipe 28. However, the concentration sensor 30 may be disposed to the fuel tank 24, or the like, other than the high pressure fuel pipe 28, but it is preferable to dispose the concentration sensor 30 close to the injector 21.

An intake valve 31 and a discharge valve 32 are respectively disposed to an intake port and a discharge port of the engine 10. Intake air is introduced into the combustion chamber 23 by opening the intake valve 31, while an exhaust gas after combustion of the fuel is discharged into a discharge pipe 33 by opening the discharge valve 32. An ignition plug 34 is attached to the respective cylinders of a cylinder head. High voltage is applied through an ignition coil (not shown) to the ignition plug 34 at a given ignition timing. By applying the high voltage to the ignition plug 34, spark discharge is generated between counter electrodes of the each ignition plug 34. The fuel is ignited by the spark discharge and combusts in the combustion chamber 23.

A convex portion (or a cavity) is formed at the top part of the piston 22. The fuel injected by the injector 21 (i.e., fuel spray) can be guided to the electrodes of the ignition plug 34 or a peripheral region of the electrodes. When the injector 21 injects the fuel in a compression stroke, the fuel spray is guided to the electrodes of the ignition plug 34 or the peripheral region of the electrodes according to an upward movement of the piston 22.

A catalyst 35 is disposed in the discharge pipe 33 to purify the exhaust gas. The catalyst 35 may be, for example, a three-dimensional catalyst that purifies CO, HC, NOx in the exhaust gas. An air-fuel ratio sensor 36 is disposed to the discharge pipe 33 upstream side of the three-dimensional catalyst 35. The air-fuel ratio sensor 36 detects an air-fuel ratio of the air-fuel mixture (i.e., the exhaust gas). A water temperature sensor 38 is attached to the cylinder block 20 and detects an engine water temperature corresponding to an engine temperature. A crank angle sensor 39 is attached to the cylinder block 20 and outputs a crank angle signal that is a rectangular wave at every given crank angle of the engine 10 (e.g., a 10 degrees CA cycle).

The outputs from the above-described sensors 29, 30, 36, 38 and 39 are input to an electrical control unit (hereinafter ECU 40) that controls the engine control system. The ECU 40 includes a microcomputer having CPU, ROM, RAM or the like. The ECU 40 controls the fuel injection amount of the injector 21 and the ignition timing of the ignition plug 34 according to engine operating conditions. In the present embodiment, the ECU 40 may be referred to as a “determination unit”, an “injection control unit”, and a “period setting unit” in the claims.

More specifically, under an ignition timing control, the ECU 40 determines the ignition timing based on the engine water temperature and drives an igniter (not shown) to cause the ignition plug 34 to spark at the determined ignition timing.

For example, the ignition timing may be set more advanced as the engine water temperature is lower. The ignition timing may be determined based on parameters including engine load, such as intake air amount, and engine rotational speed.

Whereas, under a fuel injection control, the ECU 40 calculates a base fuel amount based on parameters including the engine load, such as the intake air amount, and the engine rotational speed. Then, the ECU 40 determines a fuel injection amount by correcting the base fuel amount according to the engine water temperature and the air-fuel ratio. In this case, the fuel injection timing is set such that the injector 21 injects the fuel in the compression stroke. Under a regular control (i.e., a normal control) of the fuel injection timing, the ECU 40 may tentatively set an injection start timing to a predetermined crank angle in the compression stroke, and then, determine the fuel injection timing according to the injection start timing. Alternatively, the ECU 40 may tentatively set an injection completion timing to a predetermined crank angle (i.e., an angle close to a top dead center (TDC)), and then, determine the fuel injection timing according to the fuel injection completion timing. The ECU 40 generates an injection signal corresponding to the fuel injection amount calculated each time and controls the injector 21 with the injection signal.

When the alcohol-containing fuel is used, the engine startability may deteriorate since the alcohol-containing fuel is more difficult to vaporize than the gasoline. Further, when the engine is started at a low temperature, the engine startability may deteriorate much more. According to the present embodiment, however, the ECU 40 determines whether an implementation condition is satisfied. The implementation condition is satisfied when (i) the alcohol concentration in the fuel is higher than a specific concentration value and (ii) the engine water temperature is lower than a specific temperature value. When the implementation condition is satisfied, the ECU 40 controls the injector 21 to inject the fuel during the compression stroke of the engine 10 and sets (i.e., controls) the injection completion timing according to the ignition timing of the ignition plug 34. In other words, when the implementation condition is satisfied, the ECU 40 controls the injector 21 to (i) begin injecting fuel during the compression stroke of the engine 10 and (ii) complete injecting fuel at the injection completion timing according to the ignition timing of the ignition device 34. This control by the ECU 40 is hereinafter referred to as an “injection completion timing control”.

By setting the injection completion timing according to the ignition timing, the fuel can be ignited before the fuel spray (i.e., combustible air-fuel mixture) diffuses from a vicinity of the ignition plug 34. As a result, sufficient ignition performance of the fuel spray can be obtained. In other words, even under a high alcohol concentration state or a low temperature environment, in which the fuel is difficult to vaporize, the ignition performance can be improved by securing a firing source in the fuel spray (i.e., a firing source before diffusing the fuel spray).

Next, an overview of the injection completion timing control will be described with FIGS. 2 and 3. FIG. 2 is a timing chart illustrating differences of the fuel injection timings when the fuel injection amounts (i.e., injection times) are different, and FIG. 3 is a timing chart illustrating differences of the fuel injection timings when the ignition timings are different.

As shown FIG. 2(a), the fuel injection starts at a timing t1 and the fuel injection terminates at a timing t2. At a timing t3, the ignition by the ignition plug 34 is performed. In this case, the ECU 40 determines an ignition margin angle Ai that is a time period from the injection completion timing to the ignition timing (i.e., a time between t2 and t3). The injection completion timing is set based on the ignition margin angle Ai. In other words, the injection completion timing is set according to the ignition timing.

Whereas, as shown in FIG. 2(b), the injection start timing is shifted to a timing t11 from the timing t1 of FIG. 2(a). In this case, the injection completion timing with respect to the ignition timing (i.e., the ignition margin angle Ai) are not changed, but the injection start timing is changed.

It is noted that injection operation and ignition operation in FIG. 3(a) are the same as those in FIG. 2(a). As shown in FIG. 3(b), the ignition timing is shifted to a timing t23 from the timing t3 of FIG. 3(a). In this case, while the injection completion timing with respect to the ignition timing are not changed (i.e., the ignition margin angle Ai2=Ai1), the fuel injection timing (i.e., both of the injection start timing and the injection completion timing) is changed. But, unlike FIG. 3(b), when the ignition timing is changed to an advance angle side, the injection completion timing is also changed to the advance angle side. As a result, the injection completion timing is shifted away from the CTDC. FIG. 4 is a flowchart showing a flow of the injection timing control. The process under the injection timing control is repeated by the ECU 40 at every given time.

In Step S11 of FIG. 4, the alcohol concentration is calculated based on a detection value by the concentration sensor 30, and the engine water temperature is calculated based on a detection value by the water temperature sensor 38. Next, in Step S12, the ECU 40 determines whether the implementation condition of the injection completion timing control is satisfied based on the alcohol concentration and the engine water temperature. In this case, the ECU 40 determines that the implementation condition is satisfied when, for example, the alcohol concentration is higher than 30% and the engine water temperature is lower than 15 degrees Celsius.

In Step S12, the ECU 40 may determine whether the implementation condition is satisfied based on a relation shown in FIG. 5. A first implementation area R1 in which the regular control is performed and a second implementation area R2 in which the injection completion timing control is performed are defined in a map as shown in FIG. 5 using parameters of the alcohol concentration and the engine water temperature. The first implementation area R1 and the second implementation area R2 are separated by a boundary line L1. When the alcohol concentration and the engine water temperature fall within the second implementation area R2, an affirmative decision is made in Step S12, whereas, when the alcohol concentration and the engine water temperature fall within the first implementation area R1, a negative decision is made in Step S12. That is, the ECU 40 determines, according to the relation shown in FIG. 5, whether the alcohol concentration is higher than a specific concentration value determined for each engine water temperature or the engine water temperature is lower than a specific temperature value determined for each alcohol concentration.

When Step S12 is negative (i.e., in the case of the first implementation area R1 in FIG. 5), the process proceeds to Step S13 and the regular control is performed. Under the regular control, an injection signal is generated based on, for example, a predetermined injection start timing and a fuel injection amount at the predetermined injection start timing, and the injector 21 is driven by the injection signal. In this case, “the injection start timing control” in which the injection start timing is set to a specified timing is performed.

Whereas, when Step S12 is positive (i.e., in the case of the second implementation area R2 in FIG. 5), the process proceeds to Step S14. In Step S14, the ECU 40 sets a control period Tst. This control period Tst is a period during a start period after a first engine combustion event. The start period is a period in which the injection completion timing control is performed after the engine start. In other words, the injection completion timing control is started immediately after the engine start. Therefore, “the control period Tst” may be defined as a period from the first combustion event of the engine 10 to the termination of the injection completion timing control after the engine start by an engine starter.

In the present embodiment, in the start period in which the injection completion timing control is performed after the engine start, a period until the first combustion event is not set as the control period Tst, but a period after the first combustion event is set as the control period Tst. This is why warming up of the engine 10 by combustion, such as heat receiving by engine components (such as the cylinder block, etc.), is not performed in the period until the first combustion event, and thus, the vaporization of the fuel is not promoted in this period. However, alternatively, a period that includes the period until the first combustion event (i.e., the period until the first combustion event+the period after the first combustion event) may be set as the control period Tst. In this case, the following formula is held.

The Start Period=The Control Period Tst

More specifically, in this embodiment, the control period Tst is set using a relation shown in FIG. 6. In FIG. 6, the implementation area R2 of the injection completion timing control, which is the same as shown in FIG. 5, is set in a map using the parameters of the alcohol concentration and the engine water temperature. In the implementation area R2, the control period Tst is variably set. Specifically, the control period Tst is lengthened as the alcohol concentration increases or the engine water temperature decreases.

In Step S15, the ECU 40 determines whether the process is under the control period Tst. When the process is under the control period Tst, the process proceeds to Step S16, whereas, when the process is not under the control period Tst, the process proceeds to Step S13 as already described above. When the control period Tst is set as the period after the first combustion event, the first combustion event of the engine 10 may be detected by the engine rotational speed, more specifically, an increase change of the engine rotational speed. Therefore, based on a timing when the first combustion event is detected, the ECU 40 may determine whether the process is under the control period Tst. After Step S16, the injection completion timing control is performed. Under the injection completion timing control, a compression stroke injection is performed and the injection completion timing is set according to the ignition timing. It is noted that, under the compression stroke injection, when the engine 10 is started under a state in which the alcohol concentration is higher than a given value and the engine temperature is lower than a given value, the injection completion timing is set in the compression stroke.

In Step S16, the ECU 40 determines whether the injection completion timing control is being performed. When Step S16 is negative, the process proceeds to Step S17, and the ECU 40 shifts a control mode to the injection completion timing control.

In Step S18, the ECU 40 reads the ignition timing and the fuel injection amount calculated this time. The ignition timing is calculated in a different process (not shown) based on the engine water temperature, or based on the engine load, the engine rotational speed, or the like. The fuel injection amount is calculated based on the engine load or the engine rotational speed as described above.

In Step S19, the ignition margin angle Ai defined between the injection completion timing and the ignition timing is set based on the alcohol concentration and the engine water temperature. In this case, the ignition margin angle Ai is set using the relation shown in FIG. 5. According to FIG. 5, the ignition margin angle Ai is variably set within the implementation area R2 of the injection completion timing control. In this case, the ignition margin angle Ai is set such that the injection completion timing is shifted more to a delay angle side with respect to the ignition timing as the alcohol concentration increases or the engine water temperature decreases. In other words, the ignition margin angle Ai is set such that the injection completion timing is delayed with respect to the ignition timing. Further, the ignition margin angle Ai is defined such that the injection completion timing is adjustable within an adjustable area including an area at a delay angle side with respect to the ignition timing and an area at an advance angle side with respect to the ignition timing.

More specifically, in the implementation area R2 of the injection completion timing control, an advance angle setting area Ra and a delay setting area Rb are defined. In the advance angle setting area Ra, the ignition margin angle Ai is set so as to advance the injection completion timing with respect to the ignition timing. In the delay setting area Rb, the ignition margin angle Ai is set so as to delay the injection completion timing with respect to the ignition timing. The delay setting area Rb is set such that the alcohol concentration is higher and the engine water temperature is lower than those in the advance setting area Ra. For example, the delay setting area Rb is set as an area where the alcohol concentration falls within a specified high concentration region (e.g., equal to or more than 80%) and the engine water temperature falls within a specified very low temperature region (e.g., equal to or lower than 0 degree Celsius). The specified high concentration region and the specified very low temperature region may be referred as a “specified concentration region” and a “specified temperature region” respectively.

In the advance setting area Ra, the ignition margin angle Ai is set to be a smaller angle as the alcohol concentration increases or the engine water temperature decreases. In this case, the ignition margin angle Ai is set as an advance angle amount with respect to the ignition timing. Thus, according to the ignition margin angle Ai of the advance setting area Ra, the injection completion timing is set closer to the ignition timing as the alcohol concentration of the fuel increases or the engine water temperature decreases.

Whereas, in the delay setting area Rb, the ignition margin area Ai is set to be a larger angle as the alcohol concentration increases or the engine water temperature decreases. In this case, the ignition margin angle Ai is set as a delay angle amount with respect to the ignition timing. Thus, according to the ignition margin angle Ai of the advance setting area Rb, the injection completion timing is set further away from the ignition completion timing as the alcohol concentration of the fuel increases or the engine water temperature decreases. However, in the delay setting area Rb, the ignition margin angle Ai may be fixed as the delay angle amount (i.e., a fixed value) regardless of a value of the alcohol concentration or the engine water temperature. Further, it is preferable that the ignition margin angle Ai is set to zero on a border (i.e., a boundary line L2 shown in FIG. 5) that separates the advance setting area Ra and the delay setting area Rb.

FIG. 7 is a timing chart showing the ignition margin angle Ai is variably set. As shown in FIG. 7, the ignition timings are set to be the same, while the ignition margin angles Ai are different from each other. In FIG. 7, the alcohol concentrations in FIG. 7(a), (b), (c), and (d) are higher in this order, whereas the engine water temperatures in FIG. 7(a), (b), (c), and (d) are lower in this order. The injection completion timing is advanced with respect to the ignition timing as shown in FIG. 7(a) and (b) (i.e., Ai=an advance angle value), the injection completion timing is consistent with the ignition timing as shown in FIG. 7(c) (i.e., Ai=0), and the injection completion timing is delayed with respect to the ignition timing as shown in FIG. 7(d) (i.e., Ai=a delay angle value).

When the injection completion timing is set to a delay angle side with respect to the ignition timing, diffusion of the combustion in the combustion chamber 23 can be promoted since the fuel is ignited in a state in which strength of fuel spray flow (i.e., flow rate) is relatively high in the combustion chamber 23. In other words, since powerfully sprayed fuel is directly ignited, the diffusion of the combustion can be promoted because of the strength of the fuel spray flow.

In Step S20, the injection completion timing is set according to the ignition timing using the ignition margin angle Ai. Next, in Step S21, the injection start timing is determined based on the injection completion timing set in Step S20 and the fuel injection amount in this time. Further, the injection signal is generated based on the injection start timing and the injection completion timing. The injection signal is outputted to the injector 21 and the injector 21 is driven based on the injection signal.

FIG. 8 shows graphs of the engine rotational speed at an engine start. FIG. 8(a) shows the engine rotational speed in a state in which the alcohol concentration is low and the engine water temperature is high, that is, the regular control is performed, and FIG. 8(b) shows the engine rotational speed in a state in which the alcohol concentration is high and the engine water temperature is low, that is, the injection completion timing control is performed.

In FIG. 8, cranking is started by the starter at a timing t31, and the engine rotational speed increases at a timing t32 by the first combustion event of the engine 10. In this case, after the engine rotational speed increases equal to or more than an idle rotational speed, the engine rotational speed is stabilized at the idle rotational speed. Since, the fuel is more difficult to vaporize in FIG. 8(b) than that in FIG. 8(a), the engine rotational speed gently increases after the first combustion event. However, the engine start can be attained by performing the injection completion timing control as described above. In FIG. 8, a period from the timing t31 to the timing t33 shows the start period in which the injection completion timing control is performed and a period from the timing t32 to the timing t33 shows the control period Tst. The control period Tst is set to, for example, about 1 to 2 seconds.

Effects according to the above-described embodiment are below.

When the alcohol concentration in the fuel is high and the engine 10 is in a low temperature state when the engine is started, the compression stroke injection is performed and the injection completion timing is set according to the ignition timing. As a result, even under a high alcohol concentration state or a low temperature environment, the ignition performance can be improved by securing the firing source in the fuel spray (i.e., the firing source before diffusing the fuel spray). Therefore, the engine startability can be improved when the engine is started using the alcohol-containing fuel.

The injection completion timing is set according to the ignition timing and the injection signal for driving the injector 21 is generated according to the injection completion timing. That is, the injection completion timing is determined first, and then, the injection start timing is determined according to the injection completion timing. Therefore, an interval of the injection completion timing with respect to the ignition timing (i.e., the ignition margin angle Ai) can be more improved than the case in which the injection start timing is determined first, and then the injection completion timing is determined according to the injection start timing. As a result, although the ignition timing is changed, a positional relationship between fuel spray and an ignition spark can be maintained in a proper state. Further, influences due to rotational variation of the engine 10, battery voltage fluctuation, or the like, can be suppressed, and robustness at the engine start can be secured.

As shown in FIG. 7, the injection completion timing is set to be shifted further to the delay angle side with respect to the ignition timing as the alcohol concentration increases or the engine water temperature decreases. In this case, although the fuel is more difficult to vaporize as the alcohol concentration in the fuel increases or the engine water temperature decreases, high ignitability of fuel can be maintained even under the circumstances.

The injection completion timing can be adjusted within not only the area in which the injection completion timing is advanced with respect to the ignition timing of the ignition plug 34 but also the area in which the injection completion timing is delayed with respect to the ignition timing. In this case, the diffusion of the combustion in the combustion chamber 23 can be promoted since the fuel is ignited in a state in which the strength of the fuel spray flow is relatively high in the combustion chamber 23.

When the alcohol concentration is in the specified high concentration region (equal to or more than 80%, for example) and the engine water temperature is within the specified very low temperature region (equal to or lower than 0 degree Celsius, for example), the injection completion timing is set to be delayed with respect to the ignition timing. Therefore, even under a state in which the fuel is very difficult to vaporize, the ignition performance can be secured.

The period (the control period Tst) to perform the injection completion timing control is variably set based on the alcohol concentration and the engine water temperature. That is, when the alcohol concentration in the fuel or the engine water temperature differs at every engine start, a length of a period in which the engine startability deteriorates also differs after every engine start. In view of this, by variably setting the length of the period (i.e., the control period Tst) to perform the injection completion timing control, as described above, the high ignitability of the fuel can be maintained even under a circumstance in which the alcohol concentration or the engine water temperature differs.

When the alcohol concentration is high or the engine water temperature is low, the fuel may be much more difficult to vaporize. In addition, when the engine 10 is at a low temperature, a wall of the cylinder head is also at a low temperature, which may be another cause to inhibit the fuel from vaporizing. In this respect, according to the present embodiment, the period (i.e., the control period Tst) to perform the injection completion timing control is lengthened as the alcohol concentration in the fuel increases or the engine water temperature decreases. Therefore, even under the circumstance in which the fuel is difficult to vaporize, the ignition performance can be secured as described above.

When the alcohol concentration and the engine water temperature do not fall within the second implementation area R2 (R2 in FIG. 5), the injection start timing control is performed as the regular control. Whereas, when the alcohol concentration and the engine water temperature fall within the second implementation area (R2 in FIG. 5), the injection completion timing control is performed. In this case, the fuel injection control can be suitably performed by performing selectively the injection start timing control or the injection completion timing control.

### OTHER EMBODIMENTS

Above-described embodiment may be modified as below.

In the above embodiment, the ECU (i.e., the determination unit) determines that the implementation condition is satisfied when (i) the alcohol concentration in the fuel is higher than the specific concentration value and (ii) the engine water temperature is lower than the specific temperature value is satisfied. And, when the implementation condition is satisfied, the ECU performs “the injection completion timing control”. However, the determination unit may determine that the implementation condition is satisfied when at least one of (i) an alcohol concentration in fuel supplied to the fuel injection valve is equal to or higher than the specific concentration value and (ii) a temperature of the engine (10) is equal to or lower than the specific temperature value. For example, either one of conditions may be used as below.

(1) When an alcohol concentration in the fuel is equal to or higher than a specific concentration value, “the injection completion timing control” is performed regardless of the engine water temperature; or

(2) When an engine water temperature is equal to or lower than a specific temperature value, “the injection completion timing control” is performed regardless of the alcohol concentration.

In the condition (2), after the ECU determines at least that the alcohol-containing fuel is being used, “the injection completion timing control” may be performed. The ECU 40 may determine whether the alcohol-containing fuel is being used based on, for example, refueling information indicating that the alcohol-containing fuel is refueled.

In the above embodiment, the start period (the control period Tst) is variably set based on the alcohol concentration and the engine water temperature. However, the start period may be variably set based on either one of the alcohol concentration or the engine water temperature. Further, regarding the alcohol concentration, an area in which the start period is variably set and an area in which the start period is fixed may be predetermined. As for the engine water temperature, it is the same as the alcohol concentration.

Furthermore, the start period (the control period Tst) may be variably set based on the engine rotational speed. In this case, a timing to terminate the start period may be changed according to an increase change of the engine rotational speed at the engine start. For example, the timing to terminate the start period is set earlier as the increase change is greater.

In the above embodiment, the injection completion timing is adjustable within the adjustable area including the area at the delay angle side with respect to the ignition timing and the area at the advance angle side with respect to the ignition timing. However, the injection completion timing may be adjustable only within the area at the advance angle side with respect to the ignition timing. In this case, the adjustable area is set “from a given value at an advance angle side to 0” in the implementation area R2 in FIG. 5, and the ignition margin angle Ai is set smaller (i.e., a small advance angle amount) as the alcohol concentration in the fuel increases or the engine water temperature decreases.

In the above embodiment, the injection completion timing is set according to the ignition timing and the injection signal is generated according to the injection start timing. However, the injection start timing may be set according to the ignition timing and the injection timing may be generated basis on the injection start timing. In this case, the ignition margin angle may be set as an interval between the injection start timing and the ignition timing. Even under this configuration, the injection completion timing can be controlled according to the ignition timing.

The alcohol concentration in the fuel may be calculated by an estimating calculation other than by detection value by the sensor. For example, the alcohol concentration may be estimated based on an air-fuel ratio or engine torque since the air-fuel ratio or the engine torque also differs when the alcohol concentration in the fuel differs. The engine water temperature is the same as the alcohol concentration, that is, the engine water temperature may be calculated by the estimating calculation other than by value of detection by the sensor. For example, the engine water temperature or, in actuality, a water temperature at the engine start may be estimated based on an outside air temperature.

What is claimed is:

1. A fuel injection control apparatus for an internal combustion engine including a fuel injection valve for cylinder injection and an ignition device for spark ignition, the fuel injection control apparatus comprising:
a determination unit determining that an implementation condition is satisfied when at least one of (i) an alcohol concentration in fuel supplied to the fuel injection valve is equal to or higher than a specific concentration value and (ii) a temperature of the engine is equal to or lower than a specific temperature value; and
an injection control unit configured to control the fuel injection valve, wherein
the injection control unit controls the fuel injection valve to (i) begin injecting fuel during a compression stroke of the engine and (ii) complete injecting fuel at an injection completion timing according to an ignition timing of the ignition device, during a start period after the engine is started, when the implementation condition is satisfied.

2. The fuel injection control apparatus for the internal combustion engine according to claim 1, wherein
when the implementation condition is satisfied, the injection control unit delays the injection completion timing with respect to the ignition timing as the alcohol concentration increases or the temperature of the engine decreases.

3. The fuel injection control apparatus for the internal combustion engine according to claim 1, wherein
the injection control unit sets the injection completion timing to be within an adjustable area including an area in which the injection completion timing is advanced with respect to the ignition timing of the ignition device and an area in which the ignition completion timing is delayed with respect to the ignition timing of the ignition device.

4. The fuel injection control apparatus for the internal combustion engine according to claim 3, wherein
the injection control unit advances the injection completion timing with respect to the ignition timing of the ignition device when the alcohol concentration is within a specified concentration region and the temperature of the engine is within a specified temperature region.

5. The fuel injection control apparatus for the internal combustion engine according to claim 1, wherein
the injection control unit sets the injection completion timing according to the ignition timing of the ignition device and controls the fuel injection valve according to the injection completion timing.

6. The fuel injection control apparatus for the internal combustion engine according to claim 1, wherein
a period setting unit lengthens the start period as the alcohol concentration increases or the temperature of the engine decreases.

7. The fuel injection control apparatus for the internal combustion engine according to claim 1, wherein
the injection control unit performs an injection start timing control under which an injection start timing of the fuel injection valve is set to a specified timing when the determination unit determines that the implementation condition is not satisfied, and
the injection control unit performs an injection completion timing control under which the injection completion timing is set according to the ignition timing during the start period when the determination unit determines that the implementation condition is satisfied.
